(19) United States
(12) Patent Application Publication
(10) Pub. No.: US 2021/0130597 A1
(43) Pub. Date: May 6, 2021

(54) Polystyrene and Waste Wood Product Derived Composite Material and Method of Making the Same

(71) Applicant: WE*HAVE*SOLUTIONS; LLC, Little Rock, AR (US)

(72) Inventors: Jerry Darsey, Little Rock, AR (US); Sylvia Szwedo, Little Rock, AR (US)

(21) Appl. No.: 17/091,076

(22) Filed: Nov. 6, 2020

Related U.S. Application Data
(60) Provisional application No. 62/931,477, filed on Nov. 6, 2019.

(51) Int. Cl. C08L 25/06; C08L 97/02; C08J 3/21

(52) U.S. Cl. CPC C08L 25/06; C08J 3/212; C08L 97/02

(57) ABSTRACT

A wood composite material made of a mixture of wood particles and polystyrene, where the composite is made of at least 50% polystyrene but no more than 75% polystyrene and at least 25% wood particles but no more than 50% wood particles, with some embodiments of the composite material having approximately 1% of carbon nanofibers by weight. The composite material is made by dissolving polystyrene in an organic solvent to create a slurry paste, adding wood particles to the slurry paste (and in some embodiments, adding the carbon nanofibers to the slurry paste) to create a solvent mixture, and as the solvent evaporates from the solvent mixture, the final mixture is created and hardens into the final composite.

### CROSS REFERENCE TO RELATED APPLICATIONS

This application claims the benefit of U.S. Provisional Patent Application No. 62/931,477, filed on Nov. 6, 2019, and entitled “Polystyrene and Waste Wood Product Derived Composite Material and Method of Making the Same.” Such application is incorporated by reference herein in its entirety.

### STATEMENT REGARDING FEDERALLY SPONSORED RESEARCH OR DEVELOPMENT

Not applicable.

### BACKGROUND OF THE INVENTION

Polystyrene (PS), commonly referred to as Styrofoam, is a common household material used for thermal insulation and packing material. Because PS is so inexpensive to manufacture, advancements in recycling PS have not been made. It cannot be recycled in the same process as other plastics, so most PS ends up in landfills. In fact, although PS is reported to only account for 1% of municipal solid waste, it's estimated that PS takes up nearly 25-30% of landfill space by volume. And because PS has a very stable composition, it does not degrade for hundreds of years, which is only increasing the amount of landfill space that is filled by PS. Furthermore, it has been reported that discarded PS that ends up in the oceans is breaking down into toxic styrene monomers, disrupting the habitat of many oceanic creatures and plants. A solution for recycling PS so that it can be reused in a productive, economic manner that is less harmful to our environment is needed.

One solution, as developed by the inventors hereof, is to utilize recycled PS and waste wood products to produce a wood-PS composite material. This material is not only suitable for use in construction or in other industrial uses, but also solves a massive problem with waste, as both the PS and wood waste products are often waste products with little to no value that end up in landfills or otherwise harming the environment. And the inventors hereof have determined that at appropriate wood-PS ratios, the wood-PS composite materials maintain many of the great qualities of wood building materials, but with enhanced characteristics not typically possible with traditional wood products. In addition to the ability to use often overlooked or unused waste products in a way that drastically helps the environment, the method of creating the wood-PS composite material described herein is also an easy, cost-effective way of producing these materials on a small or large scale, allowing for widespread use of these improved building materials at a lower cost and in a more environmentally friendly way.

### BRIEF SUMMARY OF THE INVENTION

Generally speaking, the present invention is directed to a wood-composite material, which may, for example, be used as a building material or for other industrial or personal purposes. The wood-composite is generally created from traditionally wasted products, including, preferably, wood particles (such as saw dust) and polystyrene. These components are mixed together and a solvent is utilized to break down the polystyrene, creating a slurry. As the solvent evaporates from the slurry, the slurry dries into a solid wood-composite material. The wood-composite material has a lot of the same beneficial characteristics as pure-wood materials, but includes beneficial characteristics not found in pure-wood materials. Because the wood-composite material has many of the same characteristics of traditional wood materials, the composite material can be used for many of the same uses as traditional wood products, including as building materials, including, for example, as structural components, paneling, decking, outdoor furniture, and fencing materials. However, while traditional wood building materials present issues when used in certain circumstances (such as in wet environments where wood materials are used for decking, bridges, etc.), the wood-composite of the present invention overcomes these traditional issues by enhancing the structural quality of the building material through the use of the polystyrene component. In order to maintain many of the desirable characteristics of pure-wood products while enhancing the overall durability of the composite material, an appropriate wood-to-polystyrene ratio must be achieved. The most effective composite material is one that includes between 60% and 70% wood (and thus more than 40% polystyrene and no less than 30% polystyrene). The most preferred ratio sees a composite made of 67% wood and 33% polystyrene. In one embodiment, carbon nanomaterials may also be added to the composite mixture (in the amount of approximately 1% of the overall composite mixture) for provide further enhancements. In particular, the inventors have determined that the addition of this amount of carbon nanomaterials facilitates cross-linking between the wood and polystyrene components, further enhancing the durability of the composite material.

These and other objects, features, and advantages of the present invention will become better understood from a consideration of the following detailed description of the preferred embodiments and appended claims in conjunction with the drawings as described following:

### BRIEF DESCRIPTION OF THE DRAWINGS

FIG. 1 shows a diagram depicting one embodiment of the composite of the present invention, the composite being made of wood fibers and polystyrene.

FIG. 2 shows a diagram depicting another embodiment of the composite of the present invention, the composite being made of wood fibers, polystyrene, and carbon nanofibers.

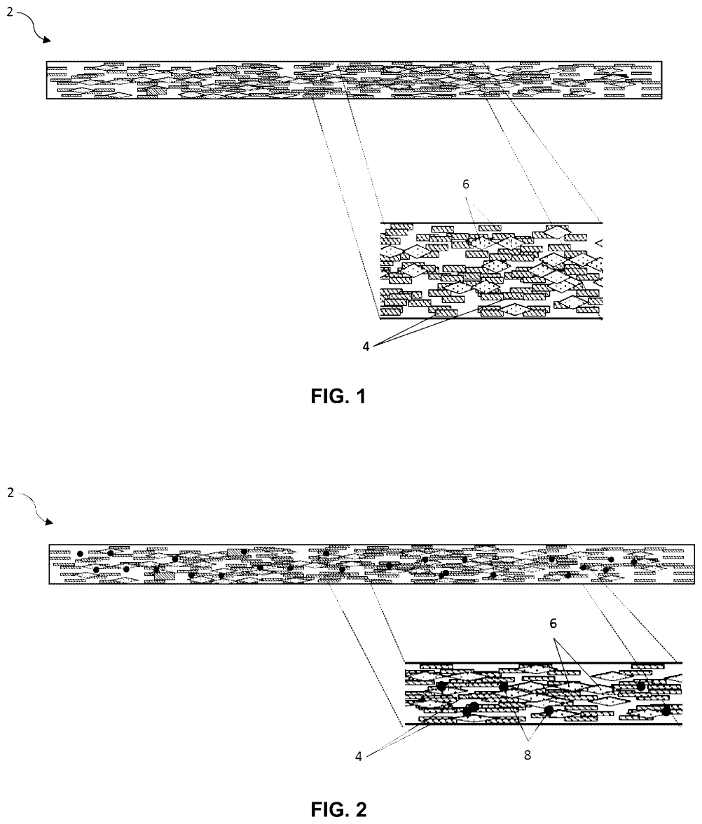

### DETAILED DESCRIPTION OF THE INVENTION

Generally speaking, the present invention is directed to an improved building material produced from commonly wasted products and a method of making the same, and in particular to a composite material 2 made up of waste wood particles 6 and waste polystyrene 4 and a method of producing such composite material 2, such that the composite material 2, when created from appropriate wood-to-polystyrene ratios, provides the beneficial characteristics of traditional pure-wood building materials but also provides enhanced characteristics that overcome issues inherent in the use of traditional pure-wood materials. Additions of other enhancing materials to the composite structure may provide additional benefits when the composite 2 is used as a building material.

In a first regard, the present invention is directed to a composite material 2 made from wood particles 6 and polystyrene 4. In one embodiment, the raw wood material component 6 consists of waste wood products like saw dust. Likewise, the raw polystyrene 4 component consists of waste or recycled polystyrene materials (such as polystyrene used as packing material, etc.). Thus, either or both of the raw materials may be sourced from waste product sources, with the preferred embodiment utilizing both raw materials sourced from waste product sources.

As it is the goal of the present invention to replace traditional pure-wood building materials (particularly where the inherent characteristics of such traditional pure-wood building materials are not suitable for most efficient use) while maintaining some of the more beneficial characteristics of such pure-wood materials (such as insulation rating, tensile strength, sound absorption, and the aesthetic appeal), the composite material 2 must have an appropriate ratio of wood 6 and polystyrene 4 materials. Where the amount of polystyrene 4 is increased above the threshold value (and thus the amount of wood 6 is reduced below the threshold value), the composite 2 loses many of the quality characteristics that make traditional pure wood a good building material. However, in the same regard, it is an object of the present invention to reduce or eliminate many of the undesirable characteristics of pure-wood materials (such as vulnerability to water damage, fire, decay, and termites), and, thus, reducing the amount of polystyrene 4 too low (and thus having wood above a certain threshold value) can result in a composite material 2 that has many of these same flaws as pure-wood materials. Thus, in order to effectively provide a composite material 2 with the benefits of true-wood materials while simultaneously reducing many of the undesirable qualities of pure-wood materials, a working range of wood-to-polystyrene ratios is required.

In the preferred embodiment, the ratio of wood-to-polystyrene materials in the composite requires at least a 50/50 mixture of wood 6 and polystyrene 4, with the upper end of the range being represented by a 75/25 poly-to-wood ratio. Thus, the composite 2 requires at minimum 50% polystyrene 4 and at maximum 75% polystyrene 4. This 50% polystyrene 4 value is the minimum threshold value as it relates to the amount of polystyrene 4 in the composite material 2, while the 75% polystyrene 4 value represents the maximum threshold value for polystyrene 4 in the composite 2. This, of course, means that the maximum threshold value of wood 6 in the composite material 2 is 50% wood 6, while the minimum threshold value of wood 6 is 25%. While these values (50/50 poly-to-wood and 75/25 poly-to-wood) represent the range of required values of wood 6 and polymer 4, the ratios are even more preferably between 65/35 poly-to-wood ratio and 70/30 poly-to-wood ratio, with the most preferred composite being made of 67% polystyrene 4 and 33% wood 6. While any percentage of composite 2 made up of polystyrene 4 between 50% and 75% (and thus wood 6 between 50% and 25%) provides benefits over pure-wood products, this particular 67/33 ratio provides a composite 2 maximizing the beneficial properties of pure wood building materials while reducing or eliminating the undesirable properties of pure wood building materials. That is, having this amount of wood 6 (33% wood) in the composite 2 allows the composite 2 to have structural integrity, tensile strength, sound absorption, and the wood-look aesthetic appeal (among other desirable properties), the inclusion approximately 33% wood 6 and 67% polystyrene 4 maximizes the enhanced characteristics of the composite 2 by providing defense to water damage, termite damage, fire damage, and damage due to decay. Too much wood 6 in the composite 2 increases the undesirable characteristics, but too much polystyrene 4 in the composite 2 and the composite 2 no longer has the desirable wood-like characteristics. Thus, an appropriate ratio is required, and preferably the 66/33 ratio is used.

As noted above, while the creation of the composite material 2 having an appropriate ratio of wood-to-polystyrene materials provides a composite 2 having sufficient structural integrity, in one embodiment of the present invention, the structural integrity of the composite 2 may be even further enhanced by the inclusion of carbon nanomaterials 8 (nanofibers) in the composite 2. These nanomaterials 8 serve to facilitate cross-linking between the wood 6 and polystyrene 4 components, thus increasing the structural integrity of the final composite material 2. In the preferred embodiment, no more than 1% of the final composite 2 material should be made of the carbon nanomaterials 8.

Having described the preferred embodiments of the composite material 2, the preferred method of manufacturing the composite material 2 may now be described. As noted above, the method begins with providing a raw wood input material from a wood material source and a raw polystyrene input material from a polystyrene source. In the preferred embodiment, the input wood material is a waste wood product such as saw dust. Likewise, the input polystyrene material is preferably a waste polystyrene product. In one embodiment, the input polystyrene material may be prepared for use in the composite material by shredding the polystyrene prior to mixing with the input wood material. Once the raw materials have been sourced, it is necessary to prepare the appropriate proportion of raw wood material to raw polystyrene material, which are then mixed together to form a mixture. As noted above, the raw materials should be prepared such that the resulting mixture of the raw materials contains no less than 25% by weight of wood and no more than 50% by weight of wood (and thus no less than 50% by weight of polystyrene and no more than 75% by weight of polystyrene).

Once the appropriate ratios are prepared, the polystyrene raw material is mixed with a solvent to dissolve the polystyrene and create a slurry paste. In the preferred embodiment the solvent is acetone, but it is also contemplated that other solvents, such as, naphthenic distillates, a 2 to 1 ratio of heptane to toluene mixture, or any other organic solvent sufficient to dissolve the polystyrene. Once the slurry paste is created, the wood raw material is introduced to the slurry paste and mixed to create a wood-solvent-polystyrene mixture. As the solvent evaporates (acetone is the preferred solvent because it evaporates easily and quickly), a hard, smooth composite product consisting of the polystyrene and wood particles is created. In one embodiment, carbon nanofibers may also be added to the wood-solvent-polystyrene mixture, making up no more than 1% of the resulting mixture of components. As solvent evaporates and the composite product is created, the carbon nanofibers facilitate crosslinking between the wood particles and polystyrene particles.

As noted, as the solvent evaporates, the wood-polystyrene composite (and in some cases the wood-polystyrene-nanofiber composite) begins to harden. If desired, before the hardening process is completed, the composite material may be molded into desired shapes, such that when the hardening process is complete, the resulting composite material is in a shape desired for use.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included. All references cited herein are hereby incorporated by reference to the extent that there is no inconsistency with the disclosure of this specification. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost.

The present invention has been described with reference to certain preferred and alternative embodiments that are intended to be exemplary only and not limiting to the full scope of the present invention.

We claim:

1. A composite material comprising 25 to 50 weight percent wood particles and 50 to 75 percent polystyrene.

2. The composite material of claim 1 consisting essentially of 67 weight polystyrene and 33 weight percent wood particles.

3. The composite material of claim 1 further comprising 1 weight percent carbon nanofibers.

4. A composite material consisting essentially of 25 to 50 weight percent wood particles and 50 to 75 percent polystyrene.

5. The composite material of claim 4 consisting essentially of 67 weight percent polystyrene and 33 weight percent wood particles.

6. A method of making a composite material comprising 50 to 75 weight percent polystyrene and 25 to 50 percent wood particles, the method comprising the steps of:
a. receiving wood particles from a wood particle source;
b. receiving polystyrene from a polystyrene source;
c. dissolving the polystyrene in an organic solvent to produce a slurry paste;
d. introducing the wood particles into the slurry paste to produce solvent mixture;
e. allowing the solvent to evaporate from the solvent mixture, resulting in a final mixture;
wherein as the solvent evaporates from the solvent mixture, the resulting final mixture material hardens to produce the composite material.

7. The method of claim 3, further comprising the step of introducing carbon nanofibers into the slurry paste to produce the solvent mixture.

8. The method of claim 3, further comprising the step of, as the solvent evaporates from the solvent mixture and before final hardening of the final mixture, molding the final mixture into a desired shape.
